(19) United States
(12) Patent Application Publication
(10) Pub. No.: US 2006/0157092 A1
(43) Pub. Date: Jul. 20, 2006

(54) Warewasher water heating system with immersion tube and associated turbulator

(76) Inventor: Steven H. Kramer, Osgood, OH (US)

Correspondence Address: THOMPSON HINE LLP, P.O Box 8801, DAYTON, OH, 45401-8801, US

(21) Appl. No.: 11/036,423

(22) Filed: Jan. 14, 2005

(51) Int. Cl. B08B 3/00; F24H 1/00

(52) U.S. Cl. 134/105; 126/350.1

(57) ABSTRACT

A warewash machine includes a housing at least in part defining a wash area. A water tank supplies water to the wash area and a water heating system is provided for heating water in the water tank. The water heating system includes a heat exchange tube immersed in water within the water tank and has an outer surface in a heat exchange relationship with the water. An infrared gas burner is at least partially disposed within the heat exchange tube for combusting an air/gas mixture and delivering combustion gases through the heat exchange tube. A turbulator is positioned within the heat exchange tube downstream of the infrared gas burner for introducing turbulence in the combustion gases traveling through the heat exchange tube.

### TECHNICAL FIELD

The present application relates to warewasher water heating systems and more particularly to a warewasher water heating system including an immersion tube with a turbulator disposed therein.

### BACKGROUND

Commercial warewashers vary significantly in their design and manner of use, but many include a water heating tank. Water may be recirculated from the tank through wash arms under pressure via a pump. In many cases, it is desirable that the temperature of the water be maintained at an approximate temperature of, e.g., about 150° F. in a high-temperature machine (one using a fresh final rinse at 180-195° F.) or, e.g., at about 140° F. in a low-temperature machine (one utilizing a final rinse mixture of fresh water and sodium hypochlorite for sanitizing, also at about 140° F.). Due to the high volume seen by many commercial warewashers, any increase in efficiency can result in substantial savings in operation costs over time.

### SUMMARY

In an aspect, a warewash machine includes a housing at least in part defining a wash area. A water tank supplies water to the wash area and a water heating system is provided for heating water in the water tank. The water heating system includes a heat exchange tube immersed in water within the water tank and has an outer surface in a heat exchange relationship with the water. An infrared gas burner is at least partially disposed within the heat exchange tube for combusting an air/gas mixture and delivering combustion gases through the heat exchange tube. A turbulator is positioned within the heat exchange tube downstream of the infrared gas burner for introducing turbulence in the combustion gases traveling through the heat exchange tube.

In another aspect, a method of increasing the efficiency of a water heating system for a warewash machine is provided. The method includes providing a first heating system configuration. The first heating system configuration includes a housing at least in part defining a wash area, a water tank for supplying water to the wash area, a water heating system for heating water in the water tank, the water heating system including a heat exchange tube within the water tank, and an infrared gas burner at least partially disposed within the heat exchange tube for combusting an air/gas mixture and delivering combustion gases through the heat exchange tube. The first heating system configuration has an efficiency during a water heating operation. The efficiency is increased by positioning a turbulator within the heat exchange tube downstream of the infrared gas burner for introducing turbulence in the combustion gases traveling through the heat exchange tube.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 top, partial section view of an embodiment of a water heating system with a heat exchange tube shown in section;

FIG. 2 is a perspective view of an embodiment of a turbulator;

FIG. 2A illustrates an angle between planar portions of the turbulator of FIG. 2;

FIG. 3 is a side, partial section view of an embodiment of a warewash machine including the water heating system of FIG. 1;

FIGS. 4 and 5 are top and perspective views of a base of the warewash machine of FIG. 3 with an outer cover removed;

FIG. 6 is a perspective view of an embodiment of a base of a warewash machine including a baffle box; and

FIG. 7 is a perspective view of the base of FIG. 6 with a sidewall of the baffle box removed.

### DETAILED DESCRIPTION

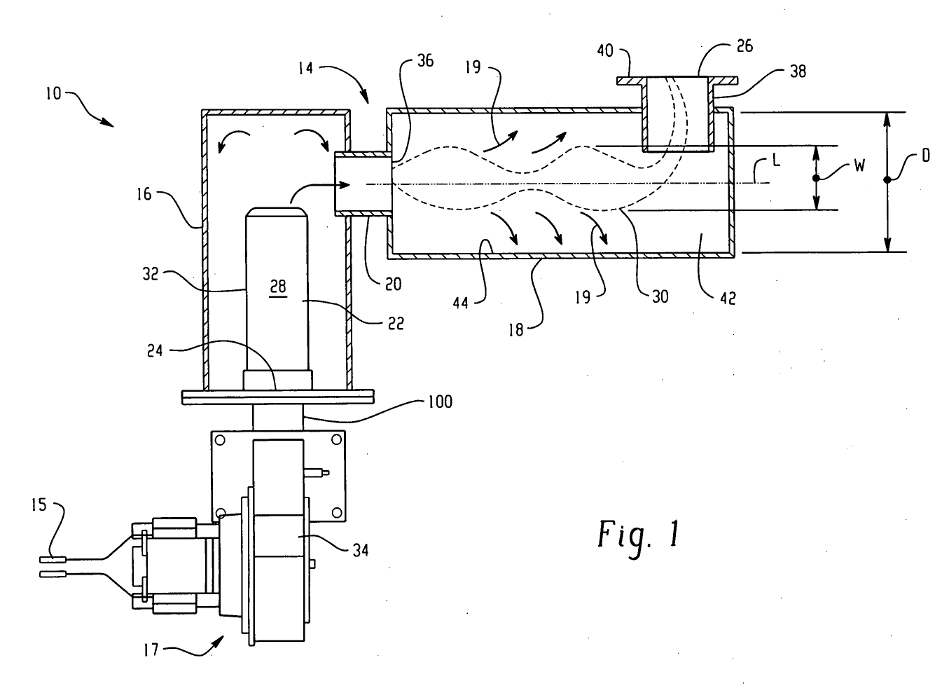

Referring to FIG. 1, a water heating system 10 includes a heat exchange tube 14 and a heater 17 including a burner 22 disposed within the heat exchange tube. The heater 17 includes control connections 15 for connecting the heater to a control unit (not shown) for controlling operation of the heater and associated burner 22 during a heating operation. In the illustrated embodiment, the heat exchange tube 14 is L-shaped including a first heat exchange portion 16, a gas inlet 24, a second heat exchange portion 18 and a gas outlet 26. A restricting portion 20 connects the first and second heat exchange portions 16, 18. The restricting portion 20 has an inner dimension to define a flow area that is less than that of the first and second heating portions 16 and 18, e.g., to induce or create back pressure for use during operation. It should be understood, however, that back pressure can be introduced anywhere in the water heating system 10 between the burner 22 and the gas outlet 26. Moreover, gas outlet 26 will typically connect with an exhaust stack and back pressure could also be induced at a location along the exhaust stack or path. As will be described in greater detail below, a turbulator 30 is located within the heat exchange tube 14 downstream of the burner 22. The turbulator 30 introduces turbulence in the heated gases traveling through the heat exchange tube.

A suitable heater 17 is an infrared (IR) heater including a gas-fired IR burner 22. Typically, such IR burners have a hollow central permeable tube about which a sleeve 32 of woven ceramic fabric is provided. When an air/gas mixture is introduced under pressure using blower 34 into the hollow tube, it flows outwardly through interstices of the woven fabric and, upon ignition of the mixture, forms the entire outer surface of the fabric to serve as an IR combustion surface 28. When the pressure of the air/gas mixture and the back pressure built into the design are properly tuned, the flame will have a burning zone that is maintained at or near the combustion surface 28. Further discussion of operation of IR heaters in warewash machines can be found in U.S. Pat. No. 5,794,634, the details of which are hereby incorporated by reference as if fully set forth herein.

Referring still to FIG. 1, disposed within the second tube portion 18 is turbulator 30, which is represented by dashed lines to emphasize that turbulator 30 can be of any form suitable to introduce turbulence to the combustion gases flowing in the heat exchange tube 14. Turbulence is introduced to the combustion gas flow to force relatively hot combustion gases flowing near centerline L toward inner surface 44 of the heat exchange tube 14 (see arrows 19 of FIG. 1) and to mix the combustion gases within chamber 42, e.g., to provide a more uniform heating temperature during a heating operation. Turbulator 30 extends from an end 36 of the restricting portion 20 to outlet 26, which is formed by a flanged member 38 including flange 40. The flanged member 38 can be used to connect the heat exchange tube 14 to, for example, a flue or exhaust of a warewash machine. In an alternative embodiment, turbulator 30 may not extend to outlet 26 and may include, for example, a free end disposed within chamber 42.

In the illustrated embodiment, turbulator 30 has a maximum width W that is less than an inner dimension D of the second portion 18, e.g., to aid in assembly. In other embodiments, W may be about the same as D. Suitable materials for forming turbulator 30 include materials having a melting point high enough to withstand gas combustion temperatures, such as stainless steel, aluminum, copper, etc. Materials used to form the turbulator 30 may or may not have good thermal conductivity.

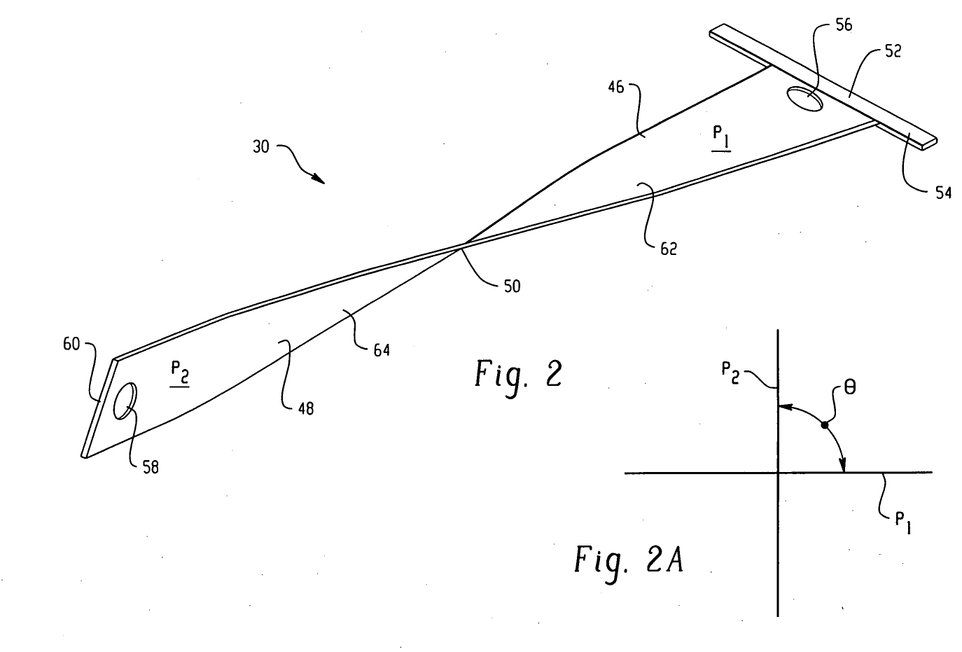

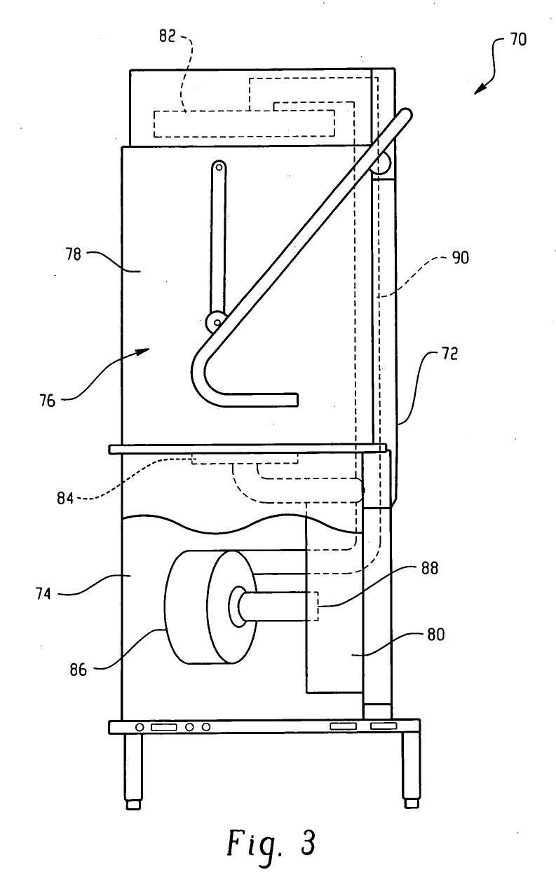

Referring to FIG. 2, an example of a turbulator 30 includes a first, relatively planar portion 46 and a second, relatively planar portion 48. First planar portion 46 and second planar portion 48 each form respective imaginary planes P₁ and P₂ that are disposed at an angle θ (in some embodiments, between about zero and 180 degrees, such as about 45 degrees or greater, such as about 90 degrees) relative to each other (FIG. 2A). An angled or twisted portion 50 of varying angular relationship with respect to P₁ and P₂ connects the first and second planar portions 46 and 48. Connected at end 52 of the turbulator 30 is a stop tab 54. While in the illustrated embodiment each portion 46, 48 and 50 has somewhat smooth front and back faces, 62 and 64, the front and back faces can be ribbed, grooved, etc.

In one embodiment, the turbulator 30 is wedged into the second portion 18 through outlet 26, with the stop tab 54 sized to prevent the turbulator 30 from entering the first portion 16 of the heat exchange tube 14 and contacting burner 22. Stop tab 54 can also provide support for fixing turbulator 30 within the chamber 42 and maintaining spacing of the relatively planar portions 46, 48 from inner surface 46 of the heat exchange tube 14. Apertures 56 and 58 are located near ends 52 and 60 to aid in manufacture of the turbulator 30 by allowing for insertion of twisting members, such as rods, of a twisting device (not shown) to, for example, cold form a preform plate into the desired shape by twisting. The turbulator 30 can provide increased system efficiency at relatively low cost.

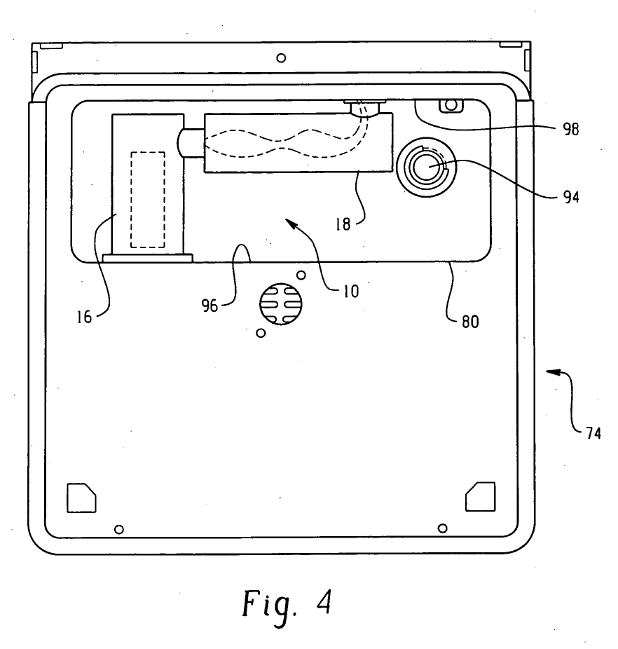

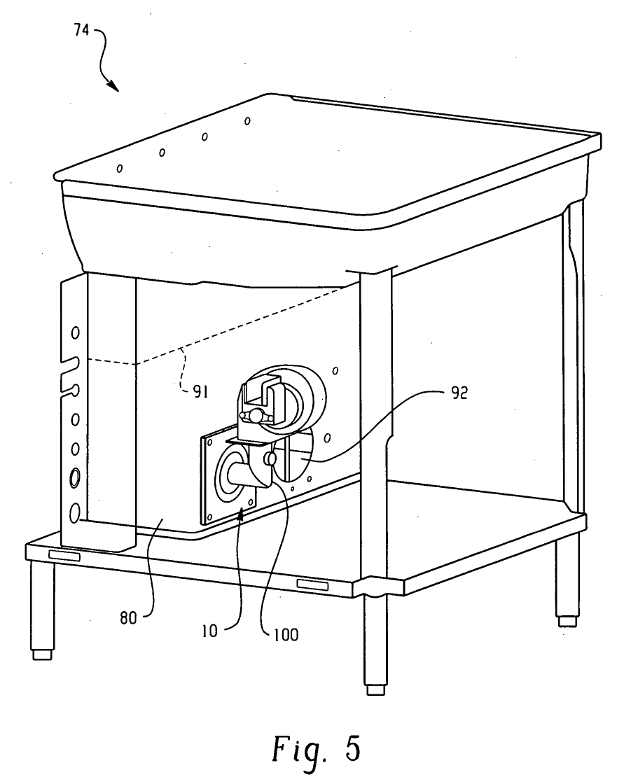

FIG. 3 is a side view of a warewash machine 70 including a housing 72 atop a base 74, a moveable door 78 and a washing chamber 76 enclosed by the moveable door 78, while FIGS. 4 and 5 show the water heating system 10 connected to a water tank 80 having a top opening that allows for communication with the washing chamber. Referring briefly to FIG. 3, this particular warewash machine embodiment is shown for illustrative purposes, it being understood that the heating system 10 can be useful with other warewash machine embodiments, such as conveyor-type warewash machines, or other types of warewash machines, for example, where detergent-laden wash water or rinse water is recirculated by a pump through one or more wash/rinse arms or other structures that spray liquid onto wares to be cleaned.

In the illustrated embodiment, moveable door 78 encloses washing chamber 76 into which racks of wares are placed between an upper wash arm 82 and a lower wash arm 84, each of which arms are supplied with spray nozzles. Water is fed to the wash arms 82, 84 by a pump 86 which can include a screened water intake 88 and is passed through a conduit 90 to the arms. The water intake 88 is adjacent to and draws water through an opening 92 (FIG. 5) to water tank 80. Water fed to the wash arms 82, 84 is directed onto wares placed in the washing chamber 76 and the water drains back into the water tank 80 from the wares, enabling recirculation of water through the tank 80 as desired.

Referring now to FIGS. 4 and 5, water can be maintained at a predetermined fill level (e.g., as shown by dashed line 91) within the water tank 80 during a washing operation. When preliminarily filled, the water tank 80 may be filled from either a separate water supply or through a conventionally-supplied water line. The level of water within the water tank 80 can be monitored, for example, using a float switch or electronic sensor (not shown), which can be operated to open and close a fill valve when the water reaches a desired level. A drain 94 is provided at the bottom of the water tank 80 and may be separate from or associated with a standpipe (not shown).

The water level may be maintained within the water tank 80 such that the heat exchange tube 14 is completely submerged within the water. Referring particularly to FIG. 4, the heat exchange tube 14 extends generally horizontally within the water tank 80 with the first portion 16 connected to a front wall 96 of the water tank 80 and the second portion 18 connected to a rear wall 98 of the water tank. A gas supply conduit 100 (FIGS. 1 and 5) extends from the blower 34 to the burner 22 for delivering the air/gas mixture to the burner.

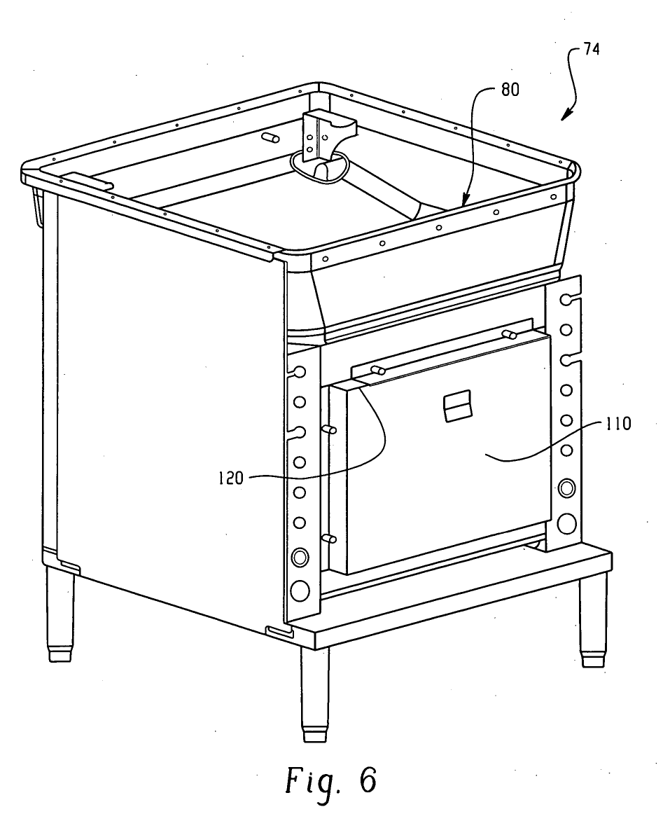

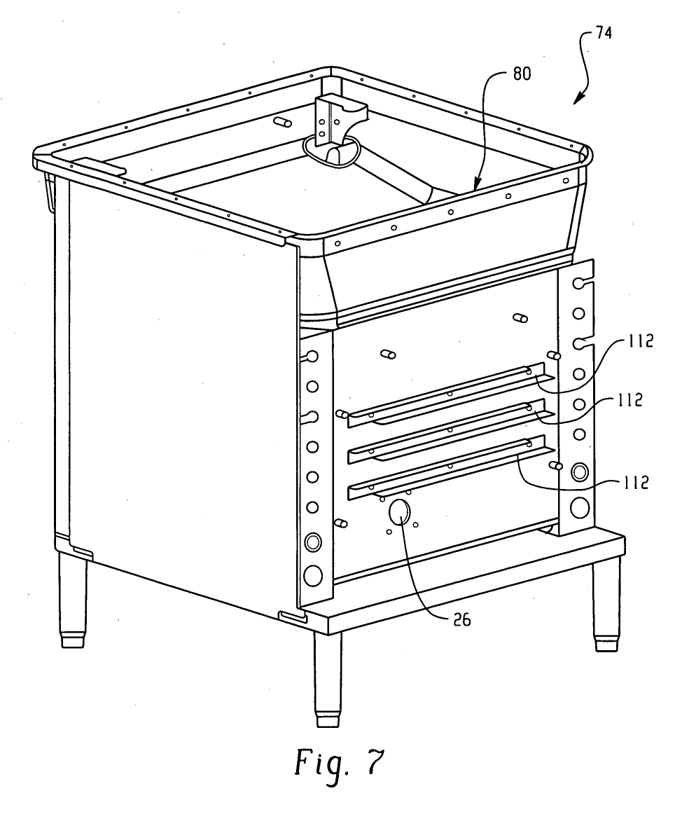

In some cases, adding turbulator 30 to the heat exchange tube 14 of a warewasher can improve heating efficiency of the warewasher by about 2 percent (e.g., compared to the same warewasher without the turbulator 30). For example, efficiency of a heating system was measured to be about 80% without turbulator 30 and, after adding turbulator 30 by securing the turbulator within the heat exchange tube 14, the efficiency of the heating system was measured to be about 82%. Efficiency of the heating system was determined by measuring the amount of heat units (BTU) and time necessary to increase the temperature of 110.6 pounds of water by 80° F. in a pilot tank including baffle box 110 as shown in FIGS. 6 and 7 using an IR heater having a BTU value UL listed at 25,000 and a heat exchange tube with a surface area of 286.9 sq inches. The following equation was used to calculate the efficiency and the results are summarized in Table I that follows.

TABLE I
$Efficiency = \frac{( Temperature Increase ) ( Weight of Water )}{( Heat Units ) ( Time )}$

| | Warewasher | Warewasher With |
|---|---|---|
| | Without Turbulator | Turbulator |
| Efficiency | 80 | 82 |
| (percent) | | |
| Weight of Water | 110.6 | 110.6 |
| (pounds) | | |
| Temperature | 80 | 80 |
| Increase (° F.) | | |
| Heat Units | 24851 | 25284 |
| (BTU) | | |
| Time (s) | 1625 | 1540 |

It is to be clearly understood that the above description is intended by way of illustration and example only and is not intended to be taken by way of limitation, and that changes and modifications are possible. For example, while an L-shaped heat exchange tube 14 is primarily described, any other suitable shape can be employed, such as a U-shaped heat-exchange tube. Moreover, additional heat transfer to the water might be achieved by including a baffle box along a bottom wall of the water tank to receive the combustion gases from the heat exchange tube and/or including a baffle box along a sidewall of the water tank. As an example, FIGS. 6 and 7 show base 74 including a baffle box 110 located along a sidewall of the water tank. Referring to FIG. 7, within the baffle box 110 baffle plates 112 direct combustion gases exiting outlet 26 along a tortuous path for additional heating of the water through the sidewall of the water tank. The baffle box 110 includes an outlet 120 for connection to an exhaust stack. In some embodiments, the turbulator could also be configured to provide flow restriction, which may induce back pressure in the heat exchange tube for more effective operation. Accordingly, other embodiments are contemplated.

What is claimed is:

1. A warewash machine comprising:
a housing at least in part defining a wash area;
a water tank for supplying water to the wash area;
a water heating system for heating water in the water tank, the water heating system including a heat exchange tube immersed in water within the water tank and having an outer surface in a heat exchange relationship with the water;
an infrared gas burner at least partially disposed within the heat exchange tube for combusting an air/gas mixture and delivering combustion gases through the heat exchange tube; and
a turbulator positioned within the heat exchange tube downstream of the infrared gas burner for introducing turbulence in the combustion gases traveling through the heat exchange tube.

2. The warewash machine of claim 1, wherein the turbulator includes a first planar portion defining a first plane and a second planar portion defining a second plane, the second plane intersecting the first plane at an angle greater than zero degrees and less than 180 degrees.

3. The warewash machine of claim 2, wherein the angle is about 90 degrees.

4. The warewash machine of claim 2 comprising an angled or twisted portion connecting the first and second planar portions and having a varying angular relationship with respect to the first and second planar portions.

5. The warewash machine of claim 1, wherein the turbulator comprises stainless steel.

6. The warewash machine of claim 1, wherein the heat exchange tube is L-shaped.

7. The warewash machine of claim 1, wherein the heat exchange tube includes a first portion connected to a second portion in an offset relationship, the turbulator being at least partially housed within the second portion and not within the first portion.

8. The warewash machine of claim 7, wherein the infrared gas burner is disposed only within the first portion.

9. The warewash machine of claim 8 further comprising a restricting portion connecting the first and second portion, the restricting portion sized to define a flow area less than that of the first and second portions for creating back pressure within the first portion during use.

10. The warewash machine of claim 7, wherein the turbulator extends from an end of the second portion to an outlet of the heat exchange tube.

11. The warewash machine of claim 1, wherein the turbulator has a width less than an inner dimension of the heat exchange tube.

12. The warewash machine of claim 1, wherein the turbulator increases the efficiency of the warewash machine compared to the warewash machine with the turbulator removed.

13. The warewash machine of claim 12, wherein the increase in efficiency is about 2 percent.

14. A method of increasing efficiency of a water heating system for a warewash machine, the method comprising:
providing a first heating system configuration including a housing at least in part defining a wash area, a water tank for supplying water to the wash area, a water heating system for heating water in the water tank, the water heating system including a heat exchange tube within the water tank, and an infrared gas burner at least partially disposed within the heat exchange tube for combusting an air/gas mixture and delivering combustion gases through the heat exchange tube, the first heating system configuration having an efficiency during a water heating operation; and
increasing the efficiency of the first heating system configuration by positioning a turbulator within the heat exchange tube downstream of the infrared gas burner for introducing turbulence in the combustion gases traveling through the heat exchange tube.

15. The method of claim 14, wherein the step of increasing the efficiency includes increasing the efficiency by about 2 percent.

16. The method of claim 14 further comprising forming the turbulator from a preform plate.

17. The method of claim 16, wherein the step of forming the turbulator includes twisting the preform plate to form a first planar portion and a second planar portion offset at an angle with respect to the first planar portion.

18. The method of claim 17, wherein the angle is about 90 degrees.
